(19) United States
(12) Patent Application Publication
(10) Pub. No.: US 2014/0358743 A1
(43) Pub. Date: Dec. 4, 2014

(54) TRAVEL MISTAKE AND FRAUD DETECTION

(71) Applicant: Tina MARSEILLE, Heidelberg (DE)

(72) Inventor: Tina MARSEILLE, Heidelberg (DE)

(73) Assignee: SAP AG, Walldorf (DE)

(21) Appl. No.: 13/908,845

(22) Filed: Jun. 3, 2013

(51) Int. Cl. G06Q 40/00

(52) U.S. Cl. CPC G06Q 40/12
USPC 705/30

(57) ABSTRACT

In some example implementations, there is provided a method for mistake and fraud detection. The method may include receiving, at an expense management system, an item for reimbursement; processing, based on one or more rules, the received item to detect whether additional processing including auditing is to be performed on the received item; comparing the received item to one or more attributes obtained from metadata containing travel-related information from a plurality of users and a plurality of tenants of a multi-tenant system; and sending an indication of whether the received item is at least one of approved for payment or a mistake based on the results of the comparing. Related systems, methods, and articles of manufacture are also provided.

### TECHNICAL FIELD

This disclosure relates generally to data processing and, in particular, travel expense management.

### BACKGROUND

Travel expense management and reimbursement is a burdensome and costly function in most organizations. As a consequence, travel expense management systems may be used to process expense reimbursements, approve the expenses, and initiate payment on the reimbursements.

### SUMMARY

In some example implementations, there is provided a method. The method may include receiving, at an expense management system, an item for reimbursement; processing, based on one or more rules, the received item to detect whether additional processing including auditing is to be performed on the received item; comparing the received item to one or more attributes obtained from metadata containing travel-related information from a plurality of users and a plurality of tenants of a multi-tenant system; and sending an indication of whether the received item is at least one of approved for payment or a mistake based on the results of the comparing.

In some variations, one or more of the features disclosed herein including the following features can optionally be included in any feasible combination. The item may include one or more travel expenses. The metadata may further include third-party information for a date when the item occurred. The third-party information may include at least one of weather information, travel information, and exchange rate information. The expense management system may receive an indication to allow sharing expense information among the plurality of users and the plurality of tenants of the multi-tenant system. The expense information may be provided to the multi-tenant, when allowed by the indication. The multi-tenant system may include at least a repository including the metadata shared among the plurality of tenants. The one or more rules may include determining at least one of whether the item is received with a handwritten receipt, whether the item is received with a receipt, whether the item is for an amount exceeding a predetermined threshold. The comparing may be performed, when the processing detects the additional processing.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example system for travel fraud detection, in accordance with some example implementations;

FIG. 2 depicts an example of a process for travel fraud detection, in accordance with some example implementations;

FIG. 3 depicts another example system for travel fraud detection, in accordance with some example implementations;

FIG. 4 depicts an example multi-tenant system for travel fraud detection, in accordance with some example implementations; and

FIG. 5 depicts an example of a repository including metadata stored in a multi-tenant system, in accordance with some example implementations.

### DETAILED DESCRIPTION

Most travelers do not intentionally make mistakes when entering data on an expense report, but mistakes including fraud do occur in connection with expense reimbursement reports. To detect mistakes and fraud, a travel expense report management system may include an auditor. The auditor may be configured to process an expense report and flag, based on one or more rules, possible mistakes and/or fraud. For example, an auditor may flag, based on one or more rules, a taxi cab expense reimbursement for further auditing if the taxi cab expense reimbursement does not have a receipt, has a handwritten receipt, and/or exceeds a certain amount, all of which may indicate a reimbursement deserving of further mistake or fraud processing.

The subject matter disclosed herein relates to collecting attributes for the possible mistake/fraud and comparing those attributes to metadata. This metadata may include historical attributes obtained from prior expense reports from the traveler associated with the mistake/fraud, historical attributes from other travelers in the same company as the traveler, and historical attributes from others travelers in other companies. Returning to the cab fare example, the attributes of the cab fare may include a starting point, an end point, a length in distance, a time of day, a date, a duration of trip, a currency, a route taken, and/or a cab service provider. One or more of these attributes may be requested from the traveler by the travel management system and then compared with metadata including multi-tenant (or cloud-based data) from a plurality of users and/or tenants, such as companies opting to share travel-related data (although anonymous) to perform auditing.

To illustrate further, an expense report for a cab fare may be flagged as a possible mistake because it is a handwritten receipt for a 300 Euro cab fare trip from Mannheim to Frankfurt Airport on a given day and time. In this example, a rule may trigger the cab fare as requiring further auditing based on rules, such as a handwritten receipt or a fare exceeding a threshold cost. The auditor may then compare the attributes, such as 300 Euro, cab fare, and Mannheim to Frankfurt Airport, to historical or reference attributes in metadata. This metadata may include, as noted, previous fares for the same traveler between the same cites. The auditor may also then compare the attributes including fare to metadata from other travelers and/or companies. Based on the comparison, the auditor may identify the cab fare expense as a possible mistake/fraud and the send a message or indication to deny or reduce payment, request additional information from the traveler, notify a manager, and/or the like.

Although some of the examples described herein refer to cab fares and the reimbursement of the cab fare, any other type of expense (including non-travel expenses) may be processed and audited as well in accordance with the processes disclosed herein.

A traveler with a past mistake may, in some example implementations, be identified for enhanced or more stringent auditing for subsequent travel expense reimbursement processing.

In some example implementations, the travel expense management system and auditor may be implemented in a multi-tenant system, such as a cloud-based processor. Moreover, a repository including historical and/or reference metadata related to travel expenses may also be stored in the multi-tenant system, and the tenants (for example, entities or companies) may separately access the multi-tenant travel management system and repository to provide and/or access travel expense data, such as historical or reference information related to cab fares, to be shared among companies for purposes of auditing.

In some example implementations, the metadata may include information obtained from an interface to third-party systems. For example, traffic and weather data sources may be accessed by the auditor to determine whether a mistake or a fraud was committed. Returning to the cab fare example, weather or traffic may be accessed to determine whether traffic conditions or weather may have been the cause for the unusually high cab fare of 300 Euros.

When the auditor flags a portion of an expense report as a possible mistake/fraud, the details of the mistake/fraud may be stored as metadata for subsequent mistake/audit detection. Furthermore, the identity of the traveler may be made anonymous before being submitted to a repository shared by others including other tenants, such as users, companies, and the like, of the multi-tenant system to enable travel mistake/fraud detection.

In some example implementations, when the auditor detects a possible mistake/fraud, a message may be sent to the traveler to provide additional information. For example, the initial travel reimbursement may have listed the cab fare of 300 and the city pair of Mannheim and Frankfurt, but after detecting a possible mistake/fraud, the auditor may request additional information, such as a precise source and destination addresses, a date of travel, a time of travel, number of travelers, reason for the very high cab fare (for example, traffic, weather, and the like) and/or any other travel related attributes.

Moreover, the auditor may require the user to provide one or more attributes in a common format to facilitate comparison between users, companies, and/or the like. With additional attributes, the auditor may perform additional auditing by comparing the price and other attributes to those attributes in metadata from other travelers and/or companies.

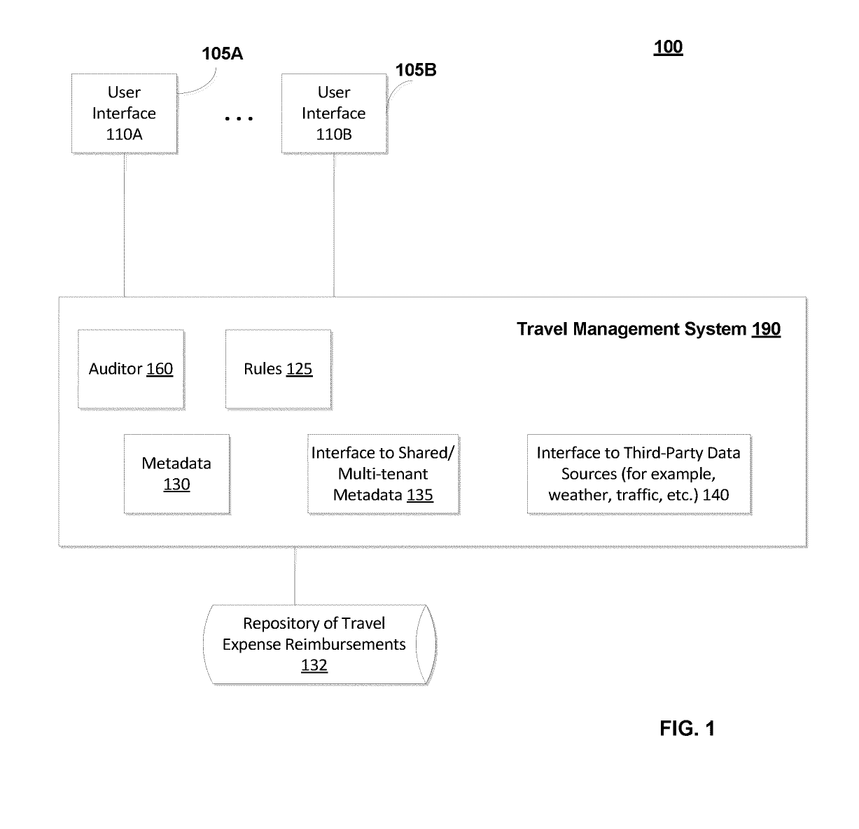

FIG. 1 depicts a system 100 including one or more client machines 105A-B including user interfaces 110A-B (for example, a browser, a client application, and the like) coupled via a network to a travel management system 190. The travel management system 190 may further include an auditor 160, one or more rules 125, metadata 130, an interface to multi-tenant metadata 135, and an interface to third-party data sources 140. The travel management system 190 may also be coupled to a repository 132, which may include metadata including travel expense reimbursement related information 132.

The auditor 160 may include at least one processor and at least one memory, and may be configured to audit travel related expense reimbursements based on metadata obtained from a plurality of travelers in a plurality of companies sharing data in a multi-tenant system, such as a so-called “cloud-based” system. The auditor 160 may use one or more rules 125 to detect a possible travel expense to determine whether additional auditing is required. Returning to the cab fare example, a rule may be defined to trigger additional auditing if a handwritten receipt is submitted, and another rule may be defined to trigger additional auditing if a threshold amount is exceeded, although other quantities and types of rules may be implemented as well.

Metadata 130 may include attributes representative of travel related expenses. For example, the metadata may include as attributes the costs of different travel related expenses based on location, time, and so forth. Moreover, this metadata may include expense related costs and the like from one or more travelers and one or more companies.

In some example implementations, an entity may opt to provide and/or access multi-tenant or cloud-based travel related expense attributes. When this is the case, the travel expense management system and auditor may access a wider-array of metadata. Returning to the cab fare example, a U.S.-based company may not have sufficient metadata to determine whether a cab fare from Mannheim to Frankfurt is reasonable, but if the company opts to share metadata with other companies, this U.S.-based company may be able to access additional data available to tenants of a multi-tenant system and/or a cloud-based repository. This additional data may include reference and/or historical metadata to compare the Mannheim to Frankfurt cab fare to other comparable fares. In some example implementations, this multi-tenant information may be made available via an interface for shared, multi-tenant data 135. The system may also include other types of data, such as weather, traffic, current exchange rates, reference prices/costs for travel related expenses in various locations around the world, and the like via interface to third-party data sources 140.

Repository 132 may be used to store metadata including travel expense reimbursements for one or more travelers at one or more different companies (or tenants of a multi-tenant system).

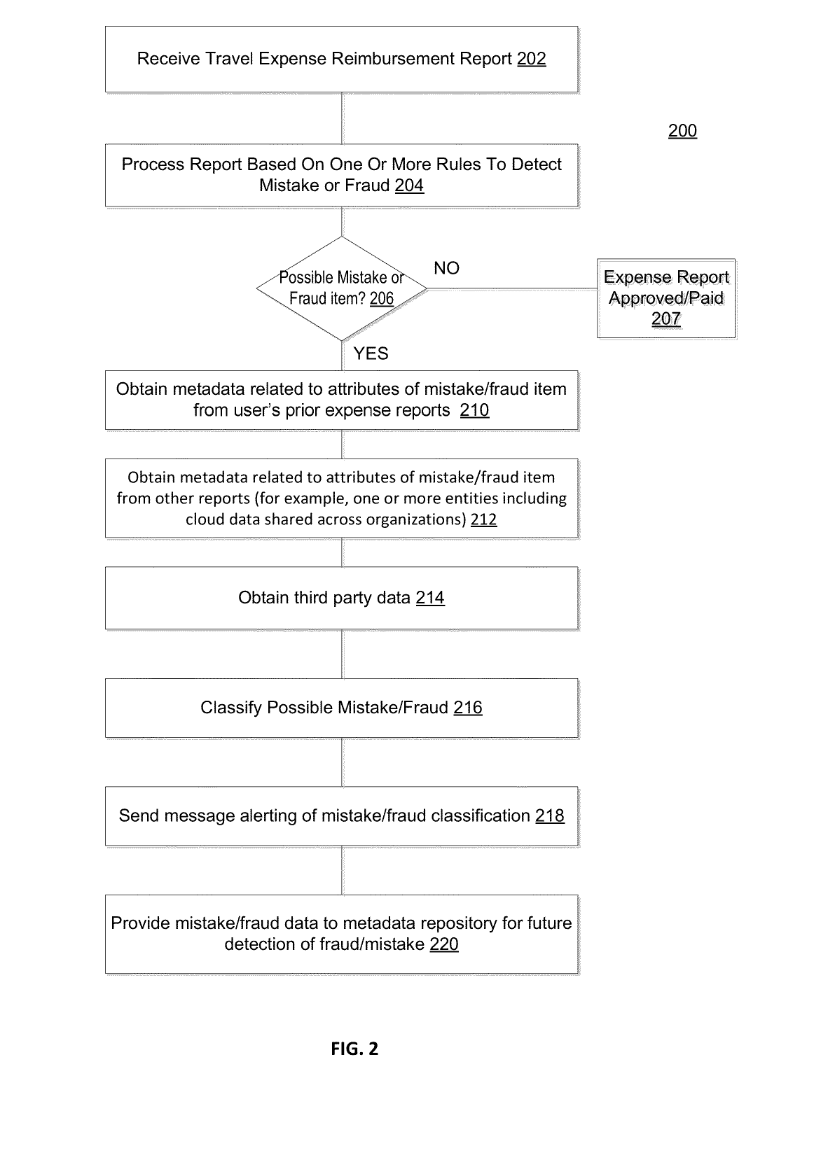

FIG. 2 depicts an example of a process for detecting travel expense mistakes and/or fraud based on metadata obtained from multi-tenants of a multi-tenant system. The description of FIG. 2 also refers to FIG. 1.

At 202, a travel expense reimbursement report may be received at travel management system 190. The travel management system 190 including auditor 160 may parse the received report to identify items on the expense report and their attributes. Returning to the cab fare example, the cab fare expense reimbursement (which in this example includes the fare amount 300 Euros and the source and destination of Mannheim to Frankfurt) may be parsed out.

At 204, the system 190 and/or auditor 160 may initially process the parsed items to identify candidate mistakes/fraud for additional auditing. For example, one or more rules 125 may be used to identify whether parsed travel items should be further audited using metadata as described further below. Returning to the cab fare example, a handwritten receipt rule or an amount over 100 Euros rule for a cab fare may trigger the additional processing. If mistakes and/or fraud are not detected, then the item may be paid at 207.

If additional auditing is required using metadata (yes at 206 and 210), the auditor 160 may obtain metadata related to the attributes of the travel expense item identified at 204. For example, the auditor 160 may access metadata including the traveler's prior expense reports to see if there is any existing metadata from prior reports stored in repository 132 that can be used to compare the current 300 Euro fare to the past fares. If so, the auditor 160 may perform a comparison to determine whether the travel expense for the cab fare is fraudulent.

At 212, the auditor 160 may also obtain metadata related to the attributes of the travel expense from other travelers at other companies. For example, auditor 160 may access via interface 135 metadata from other companies sharing data in a multi-tenant system and/or a cloud-based storage system. As noted, the traveler's company may be considered a tenant of a multi-tenant system and may opt in to share data related to expense reports (which may be anonymous) in order to detect mistake or fraud. Returning to the cab fare example, auditor 160 may send a query via interface 135 for metadata related to cab fares, between Mannheim and Frankfurt. The metadata provided by the multi-tenant system may include cab fare between those cites obtained from expense reports of other travelers at other companies. The auditor 160 may perform a comparison to determine whether the travel expense for the cab fare is fraudulent or a mistake based on this additional metadata.

At 214, the auditor 160 may also obtain other data to determine whether the travel item identified at 204 is reasonable, a mistake, or a fraud. Returning to the cab fare example, the auditor 160 may detect that a comparison to the metadata at 210 and 212 yields a possible mistake or fraud, and, when this is the case, the auditor 160 may, based on one or more rules at 125, access or obtain additional metadata from a third party system via interface 140. This metadata data may include traffic, weather, cost and price reference information for a given location (for example, cab fares posted by Frankfurt airport to various cities in Europe) and other types of information. Returning to the cab fare example, if auditor receives information that on the day of travel there were extreme delays in traffic or weather, the auditor 160 may then determine that the 300 Euro cab fare is likely not a mistake or fraud given these traffic or weather conditions.

At 216, the auditor 160 may then classify the travel item based on the comparison to the metadata and the third party information. For example, if reference or historical values for the travel expense given similar attributes are about the same, or within a statistical threshold, the requested reimbursement may be classified as reasonable and be authorized for payment. However, if reference or historical values for the travel expense given similar attributes are about less than, or exceed a statistical threshold, the requested reimbursement may be classified as likely being a mistake or fraud.

At 218, the auditor 160 may send a message via the system to indicate that the requested reimbursement has been detected at 216 as a possible fraud or mistake and/or ask for clarification (for example, additional information) from the traveler. Moreover, travel management system 190 may, at 220, provide the attributes associated with the requested reimbursement to a repository containing metadata, such as travel expense reimbursement amounts and their attributes.

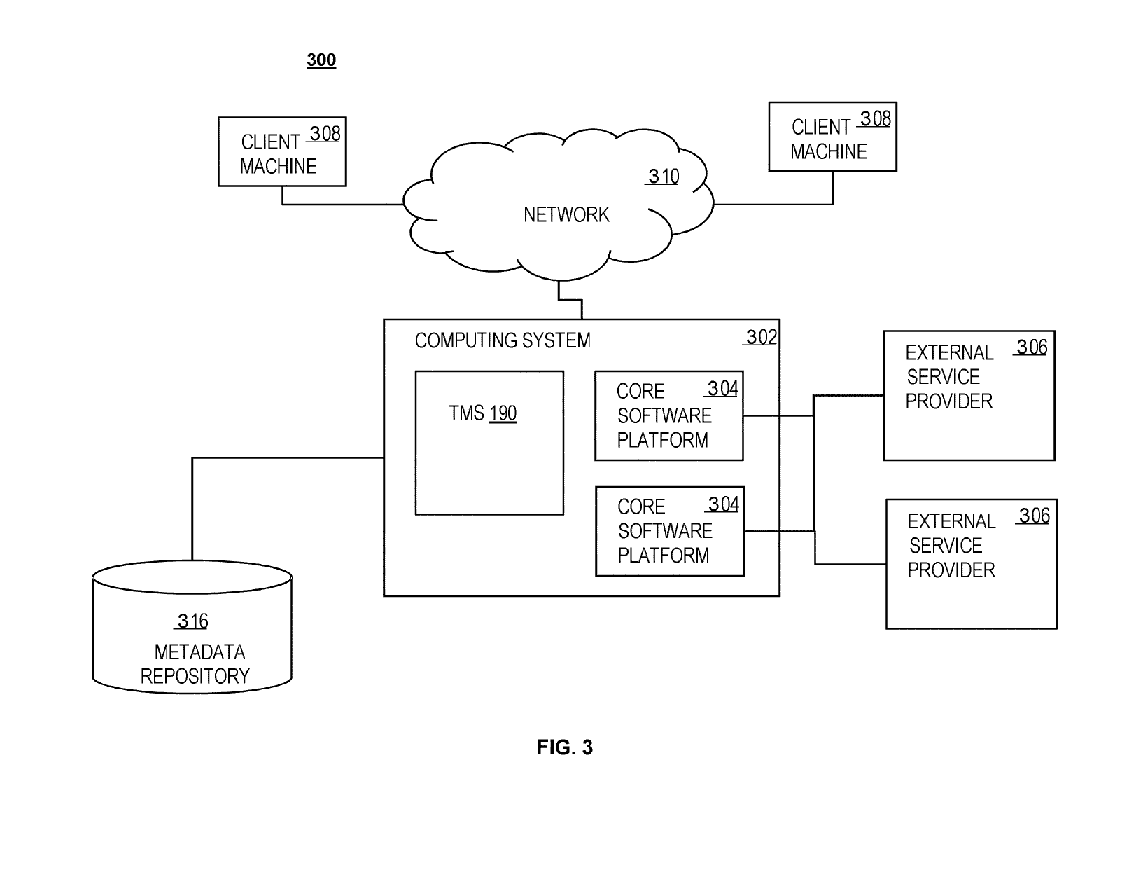

In some implementations, there may be provided a core software platform of an enterprise resource planning (ERP) system, other business software architecture, or the like can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available business software solution to work with organization-specific business processes and functions is feasible. FIG. 3 shows a diagram of a system 300 consistent with such an implementation. A computing system 302 can include one or more core software platform modules 304 providing one or more features of the business software system, such as travel management system 190, human resource management, sales force management, enterprise resource planning, and the like. The travel management system 190 including auditor 160 can optionally include one or more discrete software and/or hardware modules that perform operations such as those described herein.

The computing system 302 can also aggregate or otherwise provide a gateway via which users can access functionality provided by one or more external service providers 306. Client machines may include user interfaces 110A-B to provide access to the computing system, either via a direct connection, a local terminal, or over a network 310 (e.g., a local area network, a wide area network, a wireless network, the Internet, or the like). A travel management system 190 including auditor 160 can be hosted on the computing system 302 or alternatively, on an external system accessible over a network connection.

The travel management system 190 including auditor 160 can access one or more metadata repositories including metadata repository 316. Examples of these repositories include process repositories, scenarios repositories, transactional data repositories, and travel expense reimbursement data repositories, such as repository 132 and the like. These repositories can store definitions of business scenarios, business processes, and one or more business configurations as well as data, metadata, master data, etc. relating to definitions of the business scenarios, business processes, and one or more business configurations, and/or concrete instances of the data objects (e.g., business objects) that are relevant to a specific instance of the business scenario or a business process. In some examples, the definition can optionally be stored as a business object. For example, travel expense reports may be stored as business objects, and the individual expense items may correspond to a portion or object in the travel expense report business object. In some implementations, the business object can include a template definition of a standard business process. The template definition that can optionally be modified via one or more extensions that are stored in the one or more metadata repositories 316.

Smaller organizations can also benefit from use of business software functionality. However, such an organization may lack the necessary hardware resources, IT support, and/or consulting budget necessary to make use of a standalone business software architecture product and can in some cases be more effectively served by a software as a service (SaaS) arrangement in which the business software system architecture is hosted on computing hardware such as servers and data repositories that are maintained remotely from the organization's location and accessed by authorized users at the organization via a thin client, such as for example a web browser, over a network.

In a software delivery configuration in which services of an business software system are provided to each of multiple organizations (for example, different companies, different entities within a single company, and/or the like) are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes. These types of remote SaaS configurations can be referred to as multi-tenant systems and/or cloud-based systems.

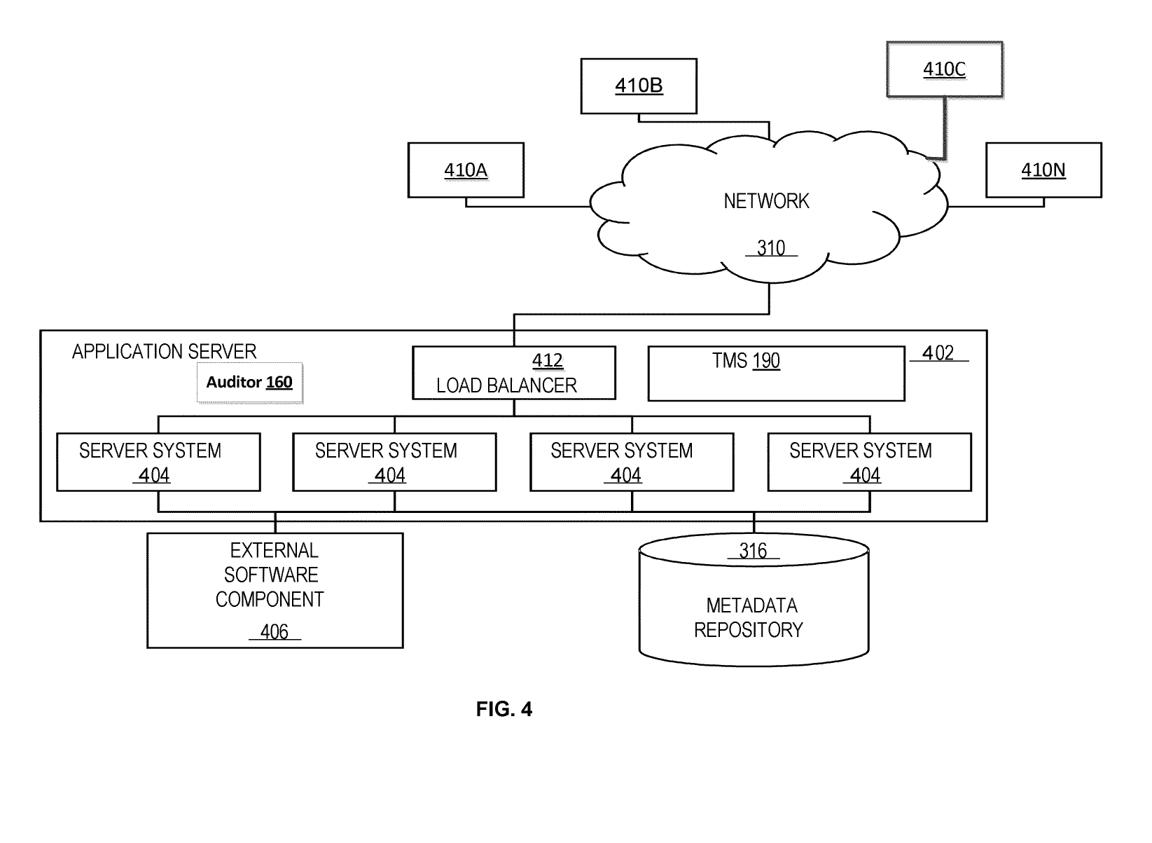

FIG. 4 shows a block diagram of a multi-tenant implementation of a software delivery architecture 400 that includes an application server 402, which can in some implementations include multiple server systems 404 that are accessible over a network 310 from client machines operated by users at each of multiple organizations 410A-410C (referred to herein as “tenants” of a multi-tenant system) supported by a single software delivery architecture 400. For a system in which the application server 402 includes multiple server systems 404, the application server can include a load balancer 412 to distribute requests and actions from users at the one or more organizations 410A-410C to the one or more server systems 404. Instances of the core software platform at 404 (not shown in FIG. 4) can be executed in a distributed manner across the server systems 404. A user can access the software delivery architecture across the network using a thin client, such as for example a web browser or the like, or other portal software running on a client machine. The application server 402 can access data and data objects stored in one or more data repositories 316. The application server 402 can also serve as a middleware component via which access is provided to one or more external software components 406 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 402 that includes multiple server systems 404 that handle processing loads distributed by a load balancer 412. Potential benefits from such an arrangement can include, but are not limited to, high and reliably continuous application server availability and minimization of unplanned downtime, phased updating of the multiple server systems 404 to permit continuous availability (one server system 404 can be taken offline while the other systems continue to provide services via the load balancer 412), scalability via addition or removal of a server system 404 that is accessed via the load balancer 412, and de-coupled lifecycle processes (such as for example system maintenance, software upgrades, etc.) that enable updating of the core software independently of tenant-specific customizations implemented by individual tenants.

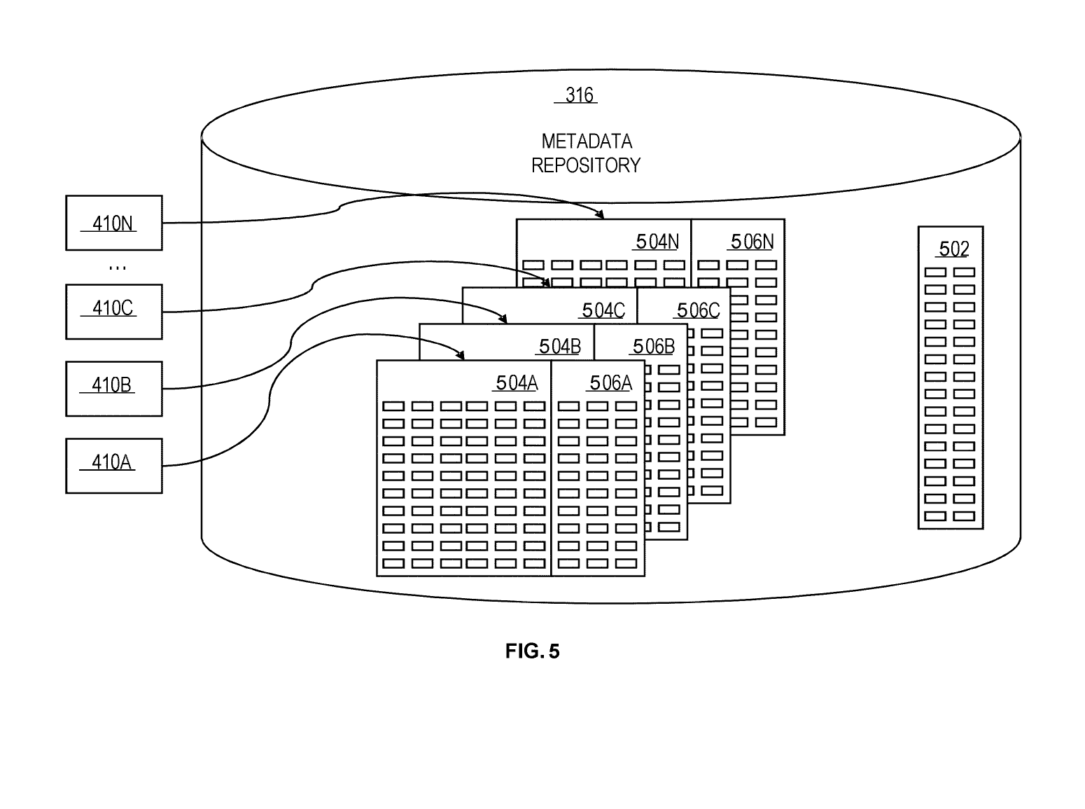

As in the example illustrated in FIG. 5, the metadata repository 316 can store a business object that represents a template definition of a standard business process, such as a travel expense report filled out by a traveler at a user interface and submitted to travel management system 412. Each individual tenant 410A-410N can customize that standard template according to the individual business process features specific to business of the organization to which that tenant is assigned. Customizations can be stored as extensions in the metadata repository.

To provide for customization of the business process for each of multiple organizations supported by a single software delivery architecture 400, the data and data objects stored in the metadata repository 316 and/or other data repositories that are accessed by the application server 402 can include three types of content as shown in FIG. 5: core software platform content 502 (e.g., a standard definition of a business process(es)), system content 504, and tenant content 506. Core software platform content 502 includes content that represents core functionality and is not modifiable by a tenant. System content 504 can in some examples be created by the runtime of the core software platform and can include core data objects that store concrete data associated with specific instances of a given business process and that are modifiable with data provided by each tenant. The data retained in these data objects are tenant-specific: for example, each tenant 410A-410N can store information about its own inventory, sales order, etc. Tenant content 506A-506N includes data objects or extensions to other data objects that are customized for one specific tenant 410A-410N to reflect business processes and data that are specific to that specific tenant and are accessible only to authorized users at the corresponding tenant. In some example implementations, the tenant content 506A-506N includes tenant specific travel related metadata as disclosed herein. Moreover, this tenant specific travel related metadata may be configured to allow sharing all or portions thereof among the tenants of system 400. Data objects can include a key field (for example “client” in the case of inventory tracking) as well as one or more of master data, business configuration information, transaction data or the like. For example, tenant content 506 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 502 and system content 504 and tenant content 506 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A non-transitory computer program product comprising a machine-readable medium storing instructions that, when executed by at least one programmable processor, cause the at least one programmable processor to perform operations comprising:
receiving, at an expense management system, an item for reimbursement;
processing, based on one or more rules, the received item to detect whether additional processing including auditing is to be performed on the received item;
comparing the received item to one or more attributes obtained from metadata containing travel-related information from a plurality of users and a plurality of tenants of a multi-tenant system; and
sending an indication of whether the received item is at least one of approved for payment or a mistake based on the results of the comparing.

2. The non-transitory computer program product of claim 1, wherein the item comprises one or more travel expenses.

3. The non-transitory computer program product of claim 1, wherein the metadata further includes third-party information for a date when the item occurred.

4. The non-transitory computer program product of claim 3, wherein the third-party information includes at least one of weather information, travel information, and exchange rate information.

5. The non-transitory computer program product of claim 1 further comprising:
receiving, at the expense management system, an indication to allow sharing expense information among the plurality of users and the plurality of tenants of the multi-tenant system.

6. The non-transitory computer program product of claim 5 further comprising:
providing, to the multi-tenant system, the expense information, when allowed by the indication.

7. The non-transitory computer program product of claim 1, wherein the multi-tenant system includes at least a repository including the metadata shared among the plurality of tenants.

8. The non-transitory computer program product of claim 1, wherein the one or more rules include determining at least one of whether the item is received with a handwritten receipt, whether the item is received with a receipt, whether the item is for an amount exceeding a predetermined threshold.

9. The non-transitory computer program product of claim 1, wherein the comparing is performed, when the processing, based on the one or more rules, detects the additional processing.

10. A method comprising:
receiving, at an expense management system, an item for reimbursement;
processing, based on one or more rules, the received item to detect whether additional processing including auditing is to be performed on the received item;
comparing the received item to one or more attributes obtained from metadata containing travel-related information from a plurality of users and a plurality of tenants of a multi-tenant system; and
sending an indication of whether the received item is at least one of approved for payment or a mistake based on the results of the comparing, wherein the expense management system comprises at least one programmable processor.

11. The method of claim 10, wherein the item comprises one or more travel expenses.

12. The method of claim 10, wherein the metadata further includes third-party information for a date when the item occurred.

13. The method of claim 12, wherein the third-party information includes at least one of weather information, and travel information, exchange rate information.

14. The method of claim 10 further comprising:
receiving, at the expense management system, an indication to allow sharing expense information among the plurality of users and the plurality of tenants of the multi-tenant system.

15. The method of claim 14 further comprising:
providing, to the multi-tenant system expense management system, the expense information, when allowed by the indication.

16. A system comprising:
at least one processor; and
at least one memory including instructions that, when executed by the at least one programmable processor, cause the at least one programmable processor to perform operations comprising:
receiving, at an expense management system, an item for reimbursement;
processing, based on one or more rules, the received item to detect whether additional processing including auditing is to be performed on the received item;
comparing the received item to one or more attributes obtained from metadata containing travel-related information from a plurality of users and a plurality of tenants of a multi-tenant system; and
sending an indication of whether the received item is at least one of approved for payment or a mistake based on the results of the comparing.

17. The system of claim 16, wherein the item comprises one or more travel expenses.

18. The system of claim 16, wherein the metadata further includes third-party information for a date when the item occurred.

19. The system of claim 18, wherein the third-party information includes at least one of weather information, and travel information, exchange rate information.

20. The system of claim 16 further comprising:
receiving, at the expense management system, an indication to allow sharing expense information among the plurality of users and the plurality of tenants of the multi-tenant system.
